(19) United States
(12) Patent Application Publication
(10) Pub. No.: US 2021/0378360 A1
(43) Pub. Date: Dec. 9, 2021

(54) FIBER-COMPOSITE-REINFORCED FOOTWEAR

(71) Applicant: Arris Composites Inc., Berkeley, CA (US)

(72) Inventors: Ethan ESCOWITZ, Berkeley, CA (US); Riley REESE, Oakland, CA (US)

(21) Appl. No.: 17/341,974

(22) Filed: Jun. 8, 2021

Related U.S. Application Data
(60) Provisional application No. 63/035,977, filed on Jun. 8, 2020.

(51) Int. Cl. A43B 17/00; A43B 7/14

(52) U.S. Cl. CPC A43B 17/003; A43B 7/1465

(57) ABSTRACT

A fiber-composite insert for footwear comprises a plurality of ribs arranged in a lattice structure, the ribs comprising a plurality of fibers in a resin-matrix.

### STATEMENT OF RELATED CASES

This case claims priority to U.S. Pat. App. 63/035,977, filed Jun. 8, 2020 and which is incorporated by reference herein.

### FIELD OF THE INVENTION

The present invention relates to footwear design, and more particularly to fiber-composite inserts for footwear, and footwear incorporating such inserts.

### BACKGROUND

Footwear technology, particularly as applied to running or other athletic shoes, has evolved to include the use of new materials. The intent of such evolution has been to improve comfort/feel, improve shock absorption, enhance efficiency, and reduce energy losses.

In running shoes, for example, plates made of carbon fiber that are embedded in the midsole act like springs, propelling a runner forward. And newly developed foams are lighter and more resilient than ever.

Notwithstanding such developments, footwear must provide a level of protection and structural stability for the wearer's feet. Footwear design thus involves tradeoffs between competing characteristics of performance, comfort, and support. This is particularly the case in athletic shoes such as running shoes, soccer cleats, and basketball sneakers. Consequently, new approaches that improve the ability to balance these competing requirements are needed.

### SUMMARY

The present invention provides fiber-composite inserts for footwear, and footwear comprising such inserts.

Embodiments of the invention provide an enhanced ability to tailor/tune characteristics of athletic footwear by tuning the characteristics of one or more different footwear components (e.g., midsole, upper, etc.) thereof, and to do so independently in the x, y, and z directions. For example, embodiments of the invention provide an ability to control stiffness, and/or alter the amount of stretch in certain directions/orientations (e.g., maintaining a tight, snug fit in the heel area, etc.), as well as an ability to provide more nearly optimized support in select regions (e.g., arch support, etc.). Moreover, embodiments of the invention provide an ability to control the amount of torsion in the footwear (i.e., limiting lateral torsion while providing natural torsion along the footbed). Additionally, embodiments of the invention provide for increased energy recovery (i.e., translating force/energy in the heel, or spikes, or cleats) through the entire shoe using fiber paths that are far closer to optimal than possible with the carbon-fiber plates of the prior art.

The aforementioned abilities, and, more generally, balancing the competing functional requirements of performance, comfort, and stability are achieved, in accordance with an illustrative embodiment of the present invention, via a fiber-composite insert for footwear having an arrangement of ribs in the form of an open lattice structure. The following parameters of the insert, among others, are adjustable to achieve specific goals for the footwear:
the specific geometry (e.g., rib cross-sectional shape, rib height, rib orientation/layout, etc.) of the fiber-composite insert;
the specific fiber alignments/pathways through the lattice of ribs;
fiber continuity or lack thereof, between various footwear components of the footwear (i.e., through different layers of footwear);
variations in the resin-to-fiber ratio along the length of continuous fiber; and
variations in the type of resin used (e.g., flexible-TPU, rigid (PC), transparent, opaque, impact absorbing, energy storing/transmitting, compliant, elastic-type resins, etc.).

The tuning of the sole or other portions of footwear using fiber orientation, fiber density, and resin type can be tailored to each individual's walking/running/jumping dynamics. Some people pronate (i.e., the heel drops inwardly) and others supinate (i.e., the heel drops outwardly). For people who pronate, more support, as achieved via fiber alignment and a relative increase in fiber density, is required on the medial/inner side of the shoe. For people who supinate, more support is needed on the lateral/outside of the shoe.

Using the same footwear shape and size, a number of aspects related to the performance and feel of a shoe are customizable in accordance with the present teachings. Consequently, a single mold tool can produce these variations by changing fiber orientation, resin type/distribution, fiber length, fiber density, and the like. A unique configuration can be determined for each individual by measuring the pressure distribution and load during running/walking/jumping. This method provides a scalable way toward mass customization, because no additional CAPEX cost is required for each unique configuration, only changes to material layup.

In some embodiments, the invention provides a fiber-composite insert for use in conjunction with footwear, wherein the insert comprises a plurality of ribs arranged as an open lattice structure, wherein a perimeter of the lattice structure has a form of a human foot, and wherein the ribs consist of a resin matrix and a plurality of fibers.

In some embodiments, the invention provides footwear comprising a fiber-composite insert disposed in the midsole of the footwear, wherein the fiber-composite insert comprises a plurality of ribs arranged as an open lattice structure, wherein a perimeter of the lattice structure has a form of a human foot, and wherein the ribs consist of a resin matrix and a plurality of fibers.

In some embodiments, the invention provides footwear including a fiber composite insert, wherein a first portion of the fiber-composite insert is disposed is a first footwear component of the footwear, and a second portion of the fiber-composite insert is disposed in a second footwear component of the footwear.

Further embodiments of the invention are described below in conjunction with the appended drawings.

### BRIEF DESCRIPTION OF THE DRAWINGS

FIGS. 1A and 1B depict, in the prior art, athletic footwear including a carbon-fiber plate.

FIG. 1C depicts, in the prior art, a laminate structure of a carbon-fiber plate for use in conjunction with footwear.

FIGS. 2A and 2B depict a fiber-composite insert for use with footwear in accordance with an illustrative embodiment of the present invention.

FIG. 2C depicts footwear incorporating the fiber-composite insert of FIGS. 2A and 2B, in accordance with the present teachings.

FIGS. 3A and 3B depict a relationship between specific stiffness and insert structure.

FIGS. 4A through 4D depict exemplary rib heights for portions of the fiber-composite insert of FIG. 2A.

FIG. 5A depicts a first embodiment of fiber paths through some of the ribs of the fiber-composite insert of FIG. 2A.

FIG. 5B depicts a second embodiment of fiber paths through some of the ribs of the fiber-composite insert of FIG. 2A.

FIG. 5C depicts a third embodiment of fibers paths through some of the ribs of a fiber-composite insert similar to that of FIG. 2A.

FIGS. 6A and 6B depict, respectively, footwear incorporating a fiber-composite insert in accordance with a further illustrative embodiment of the invention, and such a fiber-composite insert.

FIG. 7 depicts footwear in accordance with another illustrative embodiment of the invention.

FIG. 8 depicts footwear in accordance with the illustrative embodiment, wherein the footwear has different regions with different stiffness.

FIGS. 9A-9D depict footwear incorporating a trampoline heel in accordance with an embodiment of the invention.

### DETAILED DESCRIPTION

### Definitions

The following terms are defined for use in this description and the appended claims:
“Tow” means a bundle of fibers (i.e., fiber bundle), and those terms are used interchangeably herein unless otherwise specified. Tows are typically available with fibers numbering in the thousands: a 1K tow, 4K tow, 8K tow, etc.
“Prepreg” means fibers that are impregnated with resin.
“Towpreg” means a fiber bundle (i.e., a tow) that is impregnated with resin.
“Preform” means a bundle of plural, unidirectionally aligned, same-length, resin-wetted fibers. The bundle is often (but not necessarily) sourced from a long length of towpreg. That is, the bundle is a segment of towpreg that has been cut to a desired size and, in many cases, is shaped (e.g., bent, twisted, etc.) to a specific form, as appropriate for the specific part being molded. The cross section of the preform, and the fiber bundle from which it is sourced typically has an aspect ratio (width-to-thickness) of between about 0.25 to about 6. Nearly all fibers in a given preform have the same length (i.e., the length of the preform) and, as previously noted, are unidirectionally aligned. Applicant's use of the term “preform” means a fiber-bundle-based preform, and explicitly excludes any size of shaped pieces of: (i) tape (typically having an aspect ratio—cross section, as above—of between about 10 to about 30), (ii) sheets of fiber, and (iii) laminates.
“Consolidation” means, in the molding/forming arts, that in a grouping of fibers/resin, void space is removed to the extent possible and as is acceptable for a final part. This usually requires significantly elevated pressure, either through the use of gas pressurization (or vacuum), or the mechanical application of force (e.g., rollers, etc.), and elevated temperature (to soften/melt the resin).
“Partial consolidation” means, in the molding/forming arts, that in a grouping of fibers/resin, void space is not removed to the extent required for a final part. As an approximation, one to two orders of magnitude more pressure is required for full consolidation versus partial consolidation. As a further very rough generalization, to consolidate fiber composite material to about 80 percent of full consolidation requires only 20 percent of the pressure required to obtain full consolidation.
“Preform Charge” means an assemblage of preforms that are at least loosely bound together so as to maintain their position relative to one another. Preform charges can contain a minor amount of fiber in form factors other than fiber bundles, and can contain various inserts, passive or active. As compared to a final part, in which fibers/resin are fully consolidated, in a preform charge, the preforms are only partially consolidated (lacking sufficient pressure and possibly even sufficient temperature for full consolidation). By way of example, whereas applicant's compression-molding processes are often conducted at thousands of psi, the downward pressure applied to the preforms to create a preform charge in accordance with the present teachings is typically in the range of about 10 psi to about 100 psi. Thus, voids remain in a preform charge, and, as such, the preform charge cannot be used as a finished part.
“Compression molding” is a molding process that involves the application of heat and pressure to feed constituents for a period of time. For applicant's processes, the applied pressure is usually in the range of about 500 psi to about 3000 psi, and temperature, which is a function of the particular resin being used, is typically in the range of about 150° C. to about 400° C. Once the applied heat has increased the temperature of the resin above its melt temperature, it is no longer solid. The resin will then conform to the mold geometry via the applied pressure. Elevated pressure and temperature are typically maintained for a few minutes. Thereafter, the mold is removed from the source of pressure and is cooled. Once cooled, a finished part is removed from the mold.
“Footwear component” means an element, typically structural, of an item of footwear. For example, an outsole, a midsole, a heel counter, and an upper, among other elements, are all “footwear components.”
“About” or “Substantially” means+/−20% with respect to a stated figure or nominal value.

Additional definitions may be provided, in context, elsewhere in this specification. All patents and published patent applications referenced in this disclosure are incorporated by reference herein.

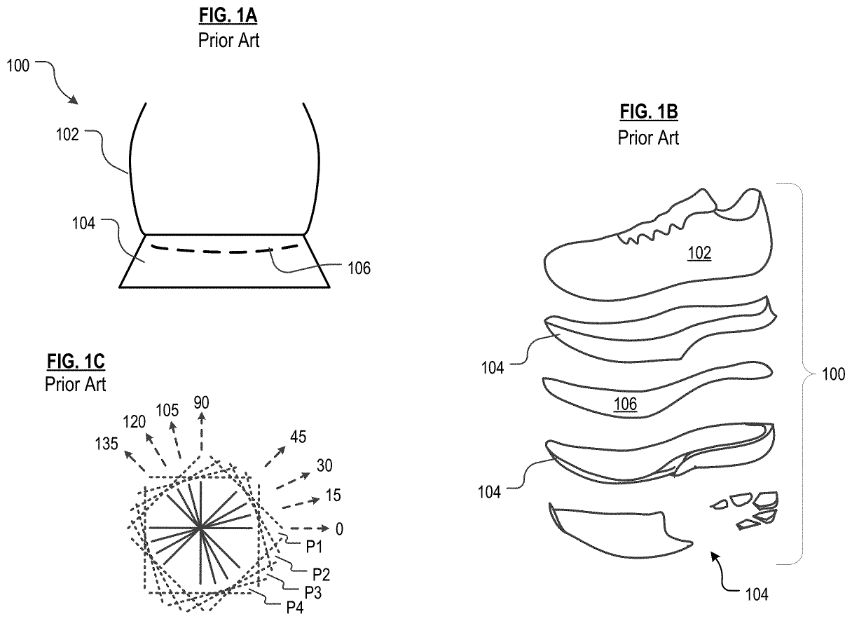

FIGS. 1A and 1B depict prior-art running shoe 100. The running shoe, which nominally includes upper 102, midsole 104, and outer sole 108, also includes carbon-fiber plate 106. The carbon-fiber plate is positioned within midsole 104, as depicted in the “exploded” view of FIG. 1B.

Carbon-fiber plate 106 is typically contoured, as depicted in FIG. 1B, to match the shape of the foot. Although somewhat curved to conform to the shape of a foot, the footbed of plate 106 is substantially flat and otherwise featureless. Carbon-fiber plate 106 is formed from plural laminae or plies of woven carbon-fiber sheets. Each such ply will typically have two groups of carbon fibers (i.e., in a weave) oriented in orthogonal, in-plane directions to one another (i.e., 0 degrees and 90 degrees).

For certain prior-art footwear applications, successive plies in such carbon-fiber plates will be slightly rotated with respect to one another, thereby creating a plate having fibers oriented in more than two, in-plane directions. For example, FIG. 1C depicts four plies P1, P2, P3, P4, each ply having fibers oriented, in-plane, at 0° and 90°, and each ply rotated by 15° with respect to its neighboring ply. A carbon-fiber plate created from such an arrangement would have fibers oriented in eight directions, as shown.

Although potentially preferable to a carbon-fiber plate having fibers running in only in-plane two directions, it will be appreciated that the fibers in such an arrangement are unlikely to align, to any major extent, with the forces exerted on a running shoe when in use.

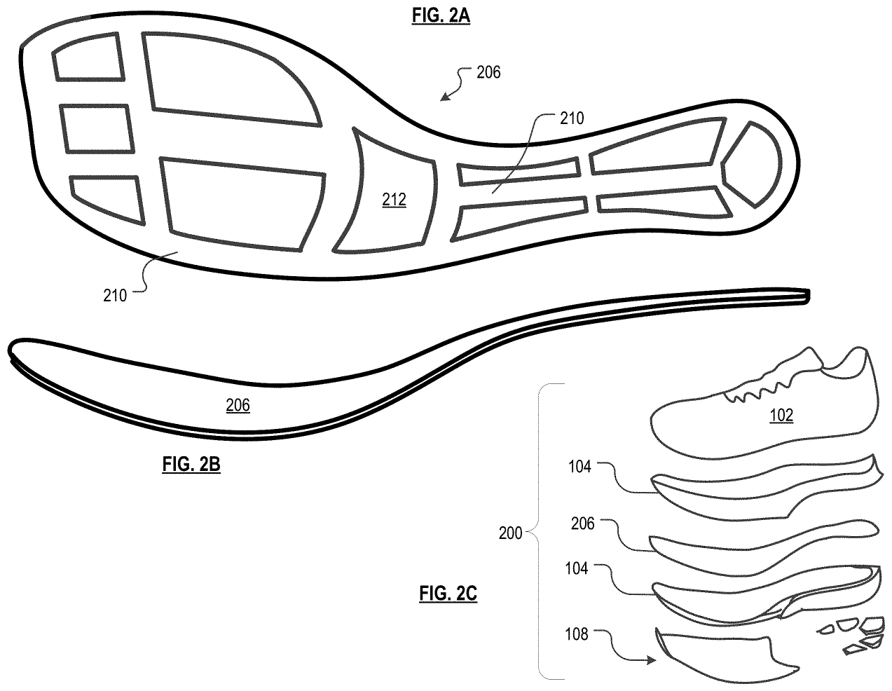

FIG. 2A (top view) and FIG. 2B (side perspective view) depict fiber-composite insert 206 in accordance with the present teachings. Insert 206 has an open-lattice construction defined by a plurality of intersecting ribs 210. In the illustrative embodiment, void regions 212 are present between ribs 210. FIG. 2C, depicts, via an exploded view, footwear 200 incorporating fiber-composite insert 206. The lattice structure of insert 206 is omitted in FIG. 2B or 2C for clarity of illustration.

As is seen in FIGS. 2A and 2B, the perimeter and side elevation of insert 206 is similar to that of prior-art carbon-fiber plates (see, e.g., FIG. 1B). That is, the perimeter defines a shape similar to that a human foot (left or right as appropriate for the one athletic shoe, etc., for which the insert is intended). And the side profile accommodates an “arch” and is made to cooperate with the shape of the midsole.

Unlike the prior art, a variety of parameters of a fiber-composite insert in accordance with the present teachings, such as insert 206, are available to alter characteristics of footwear in which the insert resides. Such parameters include, for example and without limitation:
the specific arrangement of the ribs in the lattice;
the density and distribution of intersections between ribs;
the length of the ribs between intersections;
the height(s) of the ribs;
the cross-sectional shape of the ribs;
the alignment of fibers throughout the lattice;
the fiber-to-resin ratio;
resin type; and
fiber type.

The characteristics of the footwear that can altered by variations in one or more of the aforementioned parameters include, for example and without limitation:
the stiffness of the footwear in localized regions;
the elasticity of the footwear in localized regions;
the energy absorption of the footwear;
the flex of the footwear;
the rebound of the footwear; and
the overall feel and comfort of the footwear.

The specific arrangement of the lattice structure of insert 206 (i.e., the configuration of ribs) is a function, in part, of the type of footwear in which the insert resides. For example, consider the differences in the performance requirements among a running shoe for training, a running shoe for racing, a trail-running shoe, a hiking boot, a street sneaker, cleats for football or soccer, etc. Each such item of footwear is likely to prioritize characteristics such as ankle support, comfort, weight, and stiffness, among other characteristics, differently. As an example, a designer of a trail-running shoe might put more emphasis on the footwear's relative degree of ankle support—such as provides an ability to resist an ankle “turn”— than would a designer of a race-day running shoe. This might translate, in some embodiments, to an insert for a trail-running shoe having relatively more supportive ribs (described later) toward the perimeter of the insert than the racing shoe, as well as more laterally disposed “connecting” ribs than the racing shoe to further support those perimeter-located ribs.

Although some limited ability to simulate in-use loads experienced by footwear is possible, such simulation is very complicated. Consequently, in large part, the design of the insert will be the result of empirical testing. More particularly, an insert is produced for a given footwear application based on experience or limited simulation, and then placed into the footwear in the appropriate footwear component (e.g., midsole, etc.). Lab testing is then performed, such as for bending, torsion, fatigue, etc. If the results are satisfactory, field testing via athletes, etc., follows.

The greater the number of intersections of laterally oriented (i.e., across the footbed) ribs with longitudinally oriented (i.e., along the footbed) ribs, the greater the stiffness of the insert, and hence the footwear. Conversely, as the distance between such intersections increases (i.e., the longer the rib between intersections), an insert of relatively reduced stiffness results, all other parameters being equal.

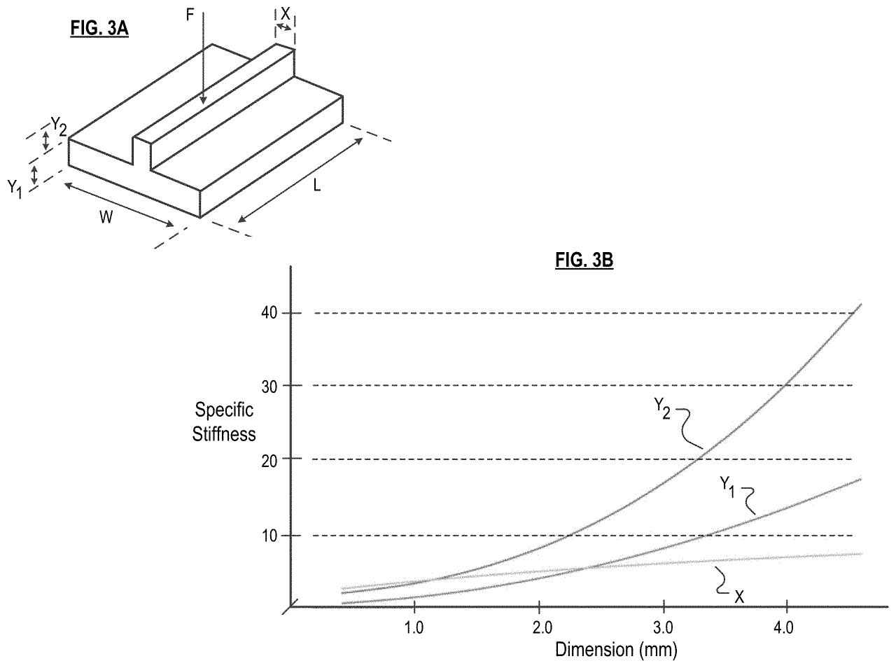

FIGS. 3A and 3B depict the relative impact of rib height and rib width on the specific stiffness (i.e., Young's modulus/mass) of the insert, and provide a comparison with the relative impact of increasing the height of sheet of the same material. The plot in FIG. 3B is based on a portion of fiber-composite material having width W of 25 mm, length L of 50 mm, a height Y1, a rib of height Y2 and width X, with a force F directed downward, orthogonal to the rib. The plot demonstrates that the use of a rib is a very efficient way (in terms of mass) to increase stiffness. It is notable that an increase in the width of the rib has little effect on specific stiffness. Note that the illustrative embodiment provides an insert having an open lattice structure of ribs; no “sheet” portion is present. In some alternative embodiments, the insert has a rib-and-sheet architecture, wherein ribs extend upwardly from a sheet of fiber-composite material.

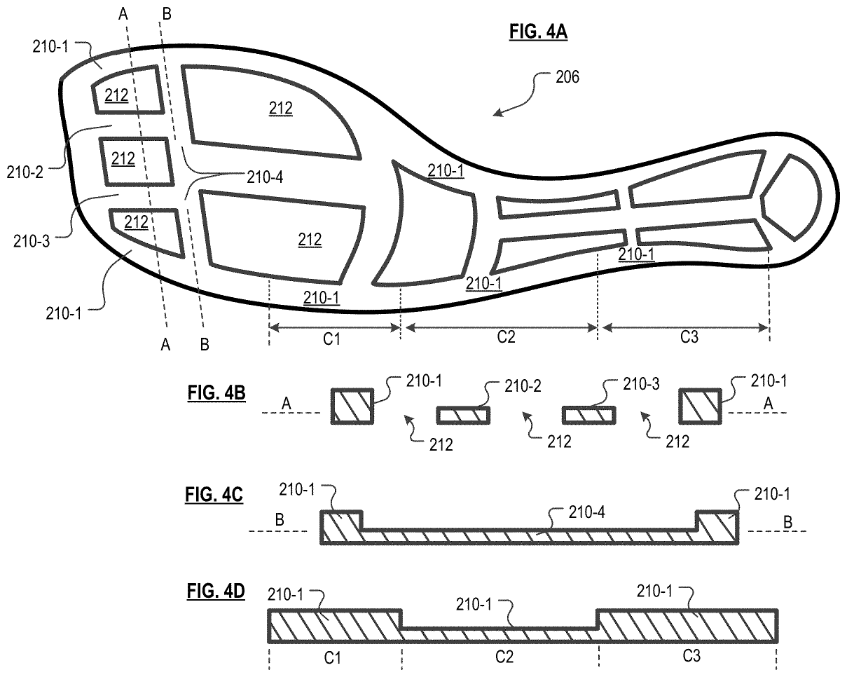

Per FIGS. 3A and 3B, the stiffness characteristic of the insert (and that of footwear incorporating the insert) can be tuned across its width or along its length by adjusting the height of the ribs, in accordance with an embodiment of the invention. For example, increasing the height of the ribs in a particular region will impart greater stiffness in that region. An example of variation in rib height at different regions of insert 206 is depicted in FIGS. 4A-4D.

FIG. 4A depicts fiber-composite insert 206 and identifies various ribs thereof; namely, ribs 210-1, 210-2, 210-3, and 210-4. Rib 210-1 is a rib located at the perimeter of insert 206. Ribs 210-2 and 210-3 are internal ribs that are longitudinally oriented (i.e., along the length of insert 206), and rib 210-4 is an internal, laterally oriented rib that connects to portions of rib 210-1.

FIG. 4B depicts a sectional view along the axis A-A of FIG. 4A. As depicted in FIG. 4B, rib 210-1 at the perimeter of insert 206 is relatively taller than internal ribs 210-2 and 210-3. Along axis A-A, a portion of rib 210-1 is separated from rib 210-2 by void 212, rib 210-2 is separated from rib 210-3 by void 212, and rib 210-3 is separated from another portion of rib 210-1 by void 212.

FIG. 4C depicts a sectional view along the axis B-B. As depicted in this Figure, laterally oriented rib 210-4 connecting the portions of rib 210-1 on opposite sides of insert 206 is lower in height than the portions of rib 210-1 connected thereby.

FIG. 4D depicts a sectional view along a portion of rib 210-1; specifically, the portions identified in FIG. 4A as C1, C2, and C3. As depicted in FIG. 4D, portion C2 of rib 210-1, located near the longitudinal midpoint of the insert, is relatively lower in height than portion C1 towards the ball of insert 206 and portion C3 towards the heel of insert 206. Such a structural arrangement would enable more torsional flex about the midpoint of insert 206 than would be the case if all three portions C1, C2, and C3 of rib 210-1 were the same height. This increased torsional flex permits, for example, a wearer's ankle to rotate while keeping the heel in place. In general, increasing the height of the rib(s) located near the perimeter of the insert reduces the amount of flex in the insert, thereby providing more stability and energy capture by preventing lateral movement of the foot.

The cross-sectional shape of ribs affects stiffness as well. As is well understood by those skilled in the art, and as follows from the second moment of inertia, a shape that positions a relatively larger fraction of its cross-sectional area (and hence its mass) relatively farther from the centroid of its cross-sectional area, increases the second moment of inertia (that is, increases stiffness). The cross-sectional shape of the rib will also impact the insert's (and footwear containing the insert) resistance to torsional deflection, as dictated by the polar second moment of inertia.

Additionally, the behavior of the sole of footwear incorporating an insert in accordance with the present teachings can be adjusted by altering the width of the insert. Changing the width of the insert alters the amount of flex in the sole of the shoe. For example, the greater the width of the insert, the greater the flex in the sole.

The alignment of fibers throughout the lattice of the fiber-composite insert is a key factor in the performance of the insert, and, therefore, in the performance of footwear incorporating the insert.

As previously mentioned, in the prior art, sheets of carbon fiber are stacked on one another and which, after molding, form a carbon-fiber plate for insertion into footwear. In contrast, a rib-based insert in accordance with the present teachings is formed from fiber-bundle-based preforms. This approach provides unprecedented ability to align fibers as required to meet performance goals.

Each fiber-bundle-based preform includes many individual, unidirectionally aligned fibers, typically in multiples of a thousand (e.g., 1k, 10k, 24k, etc.). The fibers align with the major axis of their host preform.

These fibers are typically sourced from a spool of towpreg. That is, the preforms are segments of towpreg, cut to a desired length and shaped, as appropriate for the application. As known to those skilled in the art, in towpreg, the fibers are impregnated with a polymer resin. In some other embodiments, the bundle of fibers can be sourced directly from impregnation processes, as known to those skilled in the art. Whatever the source, the fiber bundles, and hence the preforms, can have any suitable cross-section, such as, without limitation, circular, oval, trilobal, and polygonal.

The preforms are formed using a cutting/bending machine. In some embodiments, the formation of a preform involves appropriately bending towpreg, or some other source of a plurality of unidirectionally aligned resin-impregnated fibers, typically via a robot or other appropriate mechanism, then cutting the bent portion of the fiber bundle to a desired length. As appropriate, the order of the bending and cutting can be reversed. As used herein, the term “preform” means “fiber-bundle-based preform,” as described above, unless otherwise indicated.

The preforms are cut to a size and, as appropriate, shaped so that when assembled in a suitable mold, the preforms, and the fibers therein, will be aligned as desired to achieve performance goals for the insert and the footwear in which the insert will reside.

For a variety of reasons, in some embodiments, rather than adding individual fiber-bundle-based preforms to a mold cavity, one or more assemblages of such preforms—referred to herein as a “preform charge”— are placed in the mold cavity. The preform charge, which is typically a three-dimensional arrangement of preforms, is usually created in a fixture separate from the mold, and which is dedicated and specifically designed for that purpose. To create a preform charge, preforms are placed (either robotically or by hand) in a preform-charge fixture. By virtue of the configuration of the fixture, the preforms are organized into a specific geometry and then joined/tacked together. Tacking can be performed by heating the preforms and then pressing them together. Other techniques for tacking/joining include ultrasonic welding, friction welding, lasers, heat lamps, chemical adhesives, and mechanical methods such as lashing.

The preform charge, even after tacking, is not fully consolidated, but once the preforms are joined, they will not move, thereby maintaining the desired geometry and the specific alignment of each preform in the assemblage. The shape of the preform charge usually mirrors that of the intended part, or at least a portion of it, and, hence, the mold cavity (or at least a portion thereof) that forms the part. See, e.g., Publ. Pat. App. US2020/0114596 and U.S. patent application Ser. No. 16/877,236, incorporated herein by reference.

As an alternative to using a preform charge, a layup (having the same configuration as the preform charge) of individual preforms is created in the mold cavity. However, for both process efficiency as well a substantially greater likelihood that the desired preform alignment is maintained, the use of a preform charge is preferred. As used in this disclosure and the appended claims, the term “assemblage of preforms” means either a “preform charge” or a “layup” of preforms, unless otherwise indicated.

In some embodiments, each preform in an assemblage of preforms has the same composition as all other preforms (i.e., the same fiber type, fiber fraction, and resin type). These compositional parameters can, as previously mentioned, be used to achieve specific performance goals for the insert and insert-bearing footwear. For example, increasing the fiber fraction (i.e., the amount of fibers in a volume of resin matrix) will increase the strength and stiffness of the insert. In some other embodiments, some of the preforms can differ from one another, to enhance or diminish particular properties in specific regions of the insert. It is preferable, but not necessary, for all preforms to include the same resin. But to the extent different resins are used in different preforms or different assemblages, they must be “compatible,” which means that they will bond to one another. A preform assemblage can also include inserts that are not fiber based.

In some embodiments, the individual fibers in a preform are carbon fiber, although other fibers may suitably be used, either uniformly throughout the insert, or in select regions of the insert. Examples of fibers other than carbon fiber that are suitable for use with embodiments of the invention include, without limitation, glass, natural fibers, aramid, boron, metal, ceramic, polymer filaments, and others. Non-limiting examples of metal fibers include steel, titanium, tungsten, aluminum, gold, silver, alloys of any of the foregoing, and shape-memory alloys. “Ceramic” refers to all inorganic and non-metallic materials. Non-limiting examples of ceramic fiber include glass (e.g., S-glass, E-glass, AR-glass, etc.), quartz, metal oxide (e.g., alumina), aluminasilicate, calcium silicate, rock wool, boron nitride, silicon carbide, and combinations of any of the foregoing. Furthermore, carbon nanotubes can be used. Hybrid yarns consisting of twisted or commingled strands of fibers and polymer filaments can also be used as preforms.

Suitable resins for use in conjunction with the embodiments of the invention include any thermoplastic. Exemplary thermoplastic resins useful in conjunction with embodiments of the invention include, without limitation, acrylonitrile butadiene styrene (ABS), nylon, polyaryletherketones (PAEK), polybutylene terephthalate (PBT), polycarbonates (PC), and polycarbonate-ABS (PC-ABS), polyetheretherketone (PEEK), polyetherimide (PEI), polyether sulfones (PES), polyethylene (PE), polyethylene terephthalate (PET), polyphenylene sulfide (PPS), polyphenylsulfone (PPSU), polyphosphoric acid (PPA), polypropylene (PP), polysulfone (PSU), polyurethane (PU), polyvinyl chloride (PVC).

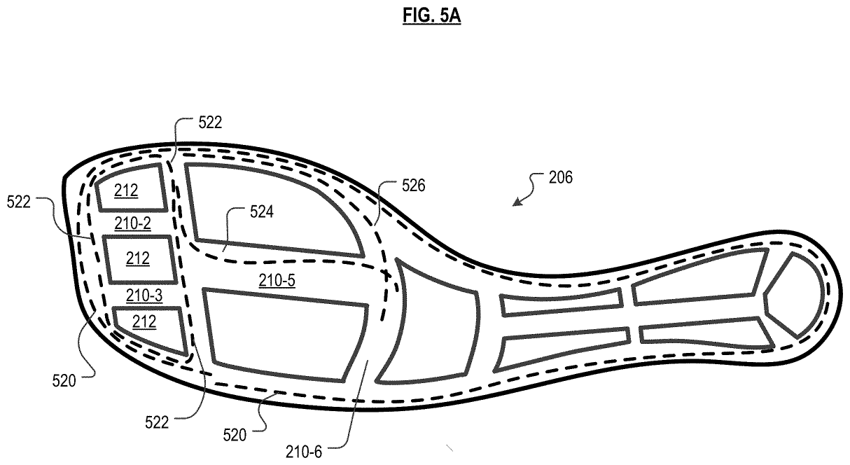

FIGS. 5A through 5C depict, for a portion of insert 206, four exemplary fibers paths, as indicated by “dashed” lines. The fiber paths can be considered to be the shape of preforms in the indicated regions, as the fibers in any given preform typically align with the long axis of the preform. It is to be understood that preforms/fibers are located everywhere that ribs are indicated; for clarity, only a few of such preforms are depicted.

FIG. 5A depicts preform 520, which is disposed near the perimeter of insert 206. As shown, preform 520, and its constituent fibers, are substantially equal in length to the perimeter of insert 206. In fact, multiple instances of preform 520 form, after subjected to compression molding, rib 210-1 (FIG. 4A). Each preform is formed from thousands of essentially same-length “continuous” fibers, all aligned in the same (albeit constantly changing) direction.

Also depicted in FIG. 5A are preforms 522, 524, and 526. Preform 522 encircles the three void regions 212 and two internal longitudinal ribs 210-2 and 210-3 near the toe of insert 206. A portion of the length of each of the fibers from preform 522 form rib 210-4, and the remaining portion contributes to the formation of rib 210-1.

A first portion of preform 524 parallels a portion of preform 522, thereby participating in the formation of lateral rib 210-4, and a second portion of preform 524 contributes to the formation of longitudinal rib 210-5. A first portion of preform 526 parallels a portion of preform 520, and a second portion of preform 526 is bent to contribute to the formation of lateral rib 210-6. A third portion of preform 524 extends into what will become lateral rib 210-6.

Overlapping the preforms/fibers as described above, and extending fibers from one rib into another rib affects the stiffness of insert 206, and an item of footwear into which it's inserted. Specifically, the greater the amount of fiber overlap (e.g., 5% of fiber length vs 10% of fiber length, etc.) the greater the increase in stiffness and strength. Also, fibers that span multiple ribs contribute to increasing the overall stiffness of the insert.

Thus, the presence vs absence of fiber overlap, the amount of overlap, and the location of overlap(s) are additional factors that can be used to tune the stiffness of the insert and provided localized differences in stiffness. As with preform 520, there will be multiple instances of the various other preforms discussed above, for forming the other ribs of insert 206.

FIG. 5B depicts another embodiment of a fiber path for insert 206. Focusing on rib 210-1, in this embodiment, two preforms—preforms 528 and 530—are required to span the full length of rib 210-1. Thus, the preforms/fibers forming rib 210-1 are discontinuous. In this embodiment, the discontinuity is located in region 532 between the ball and the heel of insert 206. Relative to the embodiment depicted in FIG. 5A wherein each fiber composing rib 210-1 spans the full length of the rib, the embodiment of insert 206 depicted in FIG. 5B will exhibit greater torsional flex. It is notable that in an actual implementation of such a fiber path, there would typically be some fiber overlap between opposed ends of the fibers from preforms 528 and 530. Once again, multiple instances of preforms 528 and preforms 530 will be required to form rib 210-1.

FIG. 5C depicts yet a third embodiment of a fiber path for an insert, once again focusing on rib 210-1. In this embodiment, as in the embodiment depicted in FIG. 5A, rib 210-1 (FIG. 1) is formed from thousands of essentially same-length “continuous” fibers, all aligned in the same (albeit constantly changing) direction. However, rather than the preforms and constituent fibers hugging the perimeter of insert 506, the preform “crosses” itself at location 536 between the ball and heel of the insert. Like the embodiment depicted in FIG. 5B, the embodiment of insert 506 depicted in FIG. 5C will exhibit greater torsional flex than the insert depicted in FIG. 5A.

FIGS. 5A through 5C thus illustrate that, for a very similar structural layout of ribs, different fiber paths through the ribs can alter properties of the insert, such as, for example, its torsional flex.

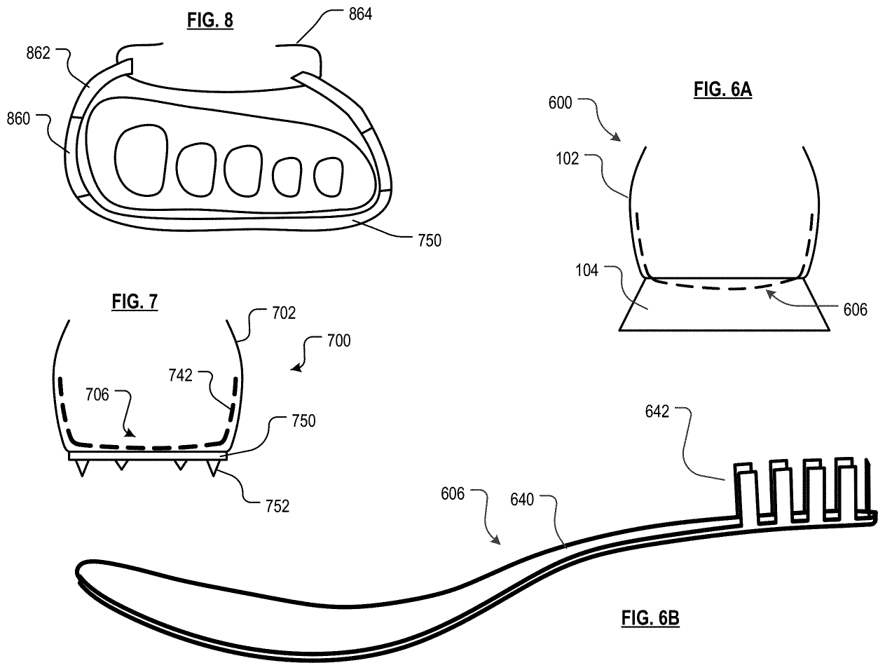

The foregoing embodiments have described how the properties of a fiber-composite insert in accordance with the present teachings can be tailored in terms of stiffness, stretch, torsional flex, and the like. And placing such an insert in footwear, such as in the midsole thereof, will likewise tailor the properties of the footwear. In some further embodiments, ribs or fibers from a midsole-sited insert extend to one or more other footwear components, such as the “upper,” etc. This enables properties, such as stiffness, to be tuned independently in the z direction, as well as in the x and y directions. For example, and referring to FIG. 8, which depicts a front cross section of a shoe on a runner's foot, different stiffness zones are illustrated, such as zones 860 and 862. Zone 862, which is relatively nearer to laces 864, is less stiff than zone 860. This would be a typical arrangement for achieving both comfort and support.

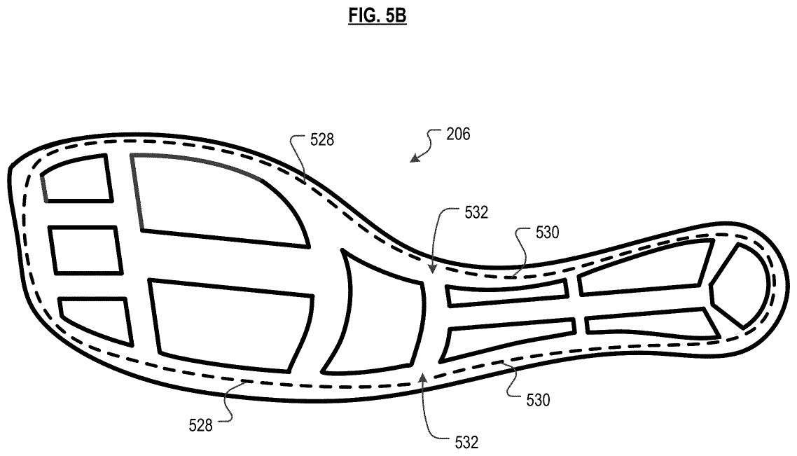

FIG. 6A depicts footwear 600, including insert 606 that is sited in more than the one of the footwear components of footwear 600. In this embodiment, ribs 642 extend upwardly from footbed 640 of insert 606, as best shown in FIG. 6B. (Note that the open lattice structure of ribs of insert 606, as per embodiments of the invention, is not depicted for the sake of clarity.) Whereas footbed 640 is positioned in midsole 104, ribs 642 extend upwards on both sides of upper 102. In the embodiment depicted in FIGS. 6A and 6B, ribs 642 are located near the back of the shoe. Ribs 640 add minimal weight, but provide significant benefits to stiffness, per FIGS. 3A, 3B and the accompanying description. In some embodiments, the upwardly extending ribs extend to the uppermost edge of upper 102.

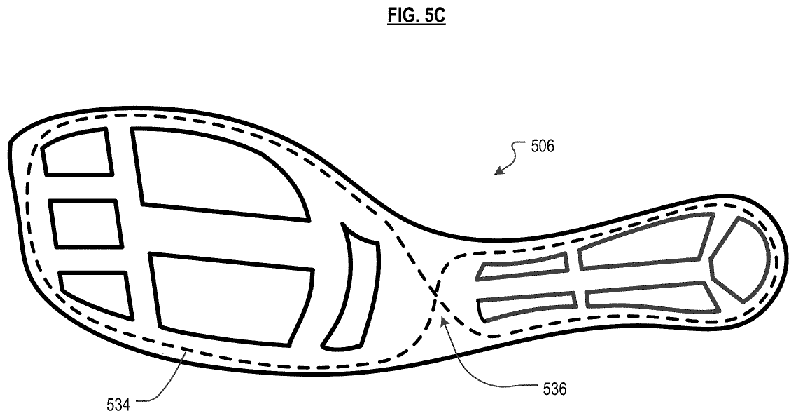

FIG. 7 depicts an embodiment of footwear 700 in accordance with the present teachings. Footwear 700 are cleats, such as soccer or football cleats. Footwear 700 includes rigid sole plate 750, studs/spikes 752, upper 702, and insert 706, among other footwear components. Insert 706 is similar to insert 606, but upwardly extending ribs 742 extend further forward along the footbed on insert 706 than ribs 642 of insert 606. As in the embodiments previously presented, the footbed of insert 706 is disposed in the midsole (not depicted). Ribs 742 extend upwards on both sides of upper 702, along the length of the footbed of the insert. The stiffness of footwear 700 can be varied from the bottom to the top of upper 702, wherein stiffness decreases with height. This can be achieved, for example, by altering the resin-to-fiber ratio, wherein the lower the ratio, the greater the stiffness. Thus, as ribs 742 extend upwardly, the resin-to-fiber ratio of the ribs increases.

In the embodiments depicted in FIGS. 6A, 6B, and 7, upwardly extending ribs couple plural footwear components (e.g., the midsole to the upper, etc.). In some further embodiments, during molding, resin-infused fiber is molded into the midsole of the shoe but continues past the midsole as dry fiber bundles (no resin). These dry fiber bundles will behave like yarn, and can be woven directly into the upper, for enhanced support. Thus, rather than providing ribs, per se, dry fiber bundles extend from the footbed of the insert.

In some embodiments, continuous fibers extend from the toe of the insert to its heel and, once at the back of insert, the fibers are oriented vertically so as to extend up the heel for maximum power transmission during acceleration from the leg into the ball of the foot.

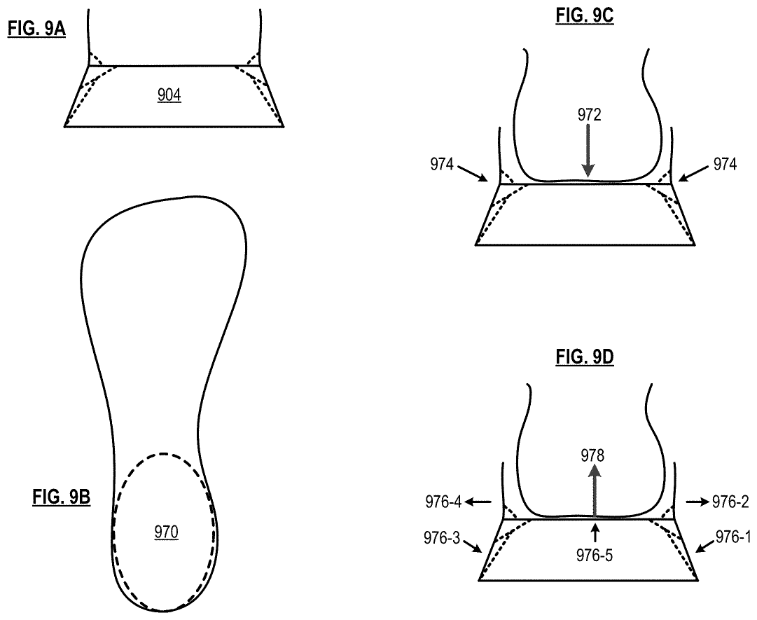

FIGS. 9A-D depict a “trampoline” shoe heel in accordance with the present teachings. FIG. 9A depicts, via cross section, the fiber alignment (dashed lines) in midsole 904, and FIG. 9B depicts fiber alignment (dashed line) in heel 970. Energy storage occurs during heel strike 972, as depicted in FIG. 9C, showing energy storage vectors 974.

FIG. 9D depicts energy release vectors 976-1 through 976-5 as rebound occurs, facilitating foot liftoff 978. In addition to fibers running from the midsole to the upper, fibers can also run continuously from the bottom of the heel through the upper. Continuous fiber features can be created in the heel that act as springs absorbing energy during impact and releasing it back to the individual. This can improve efficiency during running and jumping. This effect can be created through fiber alignment in existing shoe designs or can also be created through new designs that can include things such as leaf springs (similar to automotive suspension) or sliding surfaces.

In some further embodiments, sensors and electronics can be embedded within the fiber-composite insert. These sensors can collect information from the wearer of footwear that incorporates the insert, such as the number of steps, pace, cadence, distribution of loading (e.g., where the foot strikes the ground, where the most stress on the foot/shoe is, etc.). The sensors can also gather wear information and notify the wearer of damage or wear to the footwear. Moreover, such sensors can be used as part of the aforementioned empirical design process.

These sensors can exist as stand-alone electronic units embedded during molding. Alternatively, in embodiments in which the fiber-composite insert comprises carbon fibers, the fibers themselves can be used to gather information. More particularly, carbon fibers conduct current, and the resistance of the carbon fibers are directly correlated to the stress or deflection of the fiber. As the fibers are bent or stressed, resistance increases. If individual fibers are broken or damaged, then resistance increases even more. This resistance can be measured using an ohmmeter, which can be integrated into the tongue of the footwear or into other fabric areas thereof.

Inserts having an arrangement of ribs in the form of an open lattice structure as described in this specification are formed via compression molding, using assemblages of fiber-bundle-based preforms, per applicant's processes, as described for example in U.S. Publ. Appl. US 2020/0114596, U.S. Pat. No. 10,800,115, US 2020/0171763. Inserts in the form of a rib and sheet structure are formed via compression molding, using assemblages of fiber-bundle-based preforms and a preformed fiber-composite sheet, or plies that form a laminate sheet, or chopped fiber formed into a sheet, such as described for example in U.S. Publ. 2020/0114591. After such inserts are formed, such as via a compression-molding facility, etc., they are forwarded to the footwear manufacturer for incorporation into footwear, during its manufacturing stage, as appropriate.

It is to be understood that the disclosure describes a few embodiments and that many variations of the invention can easily be devised by those skilled in the art after reading this disclosure and that the scope of the present invention is to be determined by the following claims.

What is claimed:

1. An article comprising a fiber-composite insert for use in conjunction with footwear, the insert comprising a plurality of ribs arranged as an open lattice structure, wherein a perimeter of the lattice structure has a form of a human foot, the ribs consisting of a resin matrix and a plurality of fibers.

2. The article of claim 1 wherein the plurality of ribs includes a first rib disposed at the perimeter of the fiber-composite insert, wherein the first rib extends for a full length of the perimeter.

3. The article of claim 2 wherein the plurality of ribs includes a second rib, wherein the second rib is laterally disposed, extending across a width of the fiber-composite insert, wherein a first end of the second rib is coupled to the first rib and a second end of the second rib is coupled to the first rib.

4. The article of claim 3 wherein the plurality of ribs includes a third rib, wherein the third rib is longitudinally disposed, aligned along a length of the fiber-composite insert, wherein a first end of the third rib couples to the second rib.

5. The article of claim 2 wherein the first rib comprises a first group of fibers of the plurality of fibers, wherein each fiber in the first group has length substantially equal to the full length of the perimeter.

6. The article of claim 2 wherein the first rib comprises a first group of fibers and a second group of fibers of the plurality of fibers, wherein collectively, the fibers in the first group and the fibers in the second group have a length that is substantially equal to the full length of the perimeter.

7. The article of claim 3 wherein the first rib has a height that is different from a height of at least one of the second rib or the third rib.

8. The article of claim 2 wherein a height of the first rib varies along a length thereof.

9. The article of claim 1 wherein the open lattice structure of ribs defines a footbed, and further wherein some of the ribs extend out-of-plane of the footbed and substantially orthogonal thereto.

10. The article of claim 1 wherein the article is footwear, and wherein the fiber-composite insert is disposed in the footwear.

11. The article of claim 10 wherein the fiber-composite insert is disposed in a midsole of the footwear.

12. The article of claim 10 wherein a first portion of the fiber composite insert is disposed in a midsole of the footwear, and a second portion of the fiber composite insert is disposed in another footwear component of the footwear.

13. The article of claim 12 wherein the second portion of the fiber composite insert is disposed in an upper of the footwear.

14. The article of claim 12 wherein the first portion of the fiber composite insert is a footbed thereof, and the second portion of the fiber composite insert are ribs that extend out-of-plane of the footbed.

15. The article of claim 14 wherein, for the ribs that extend out-of-plane, a height of a portion of the ribs proximal to the footbed is greater than a height of a portion of the ribs distal to the footbed.

16. The article of claim 14 wherein, for the ribs that extend out-of-plane, a resin-to-fiber ratio of a portion of the ribs proximal to the footbed is less than a resin-to-fiber ratio of a portion of the ribs distal to the footbed.

17. The article of claim 12 wherein the first portion of the fiber composite insert is a footbed thereof, and the second portion of the fiber composite insert is a plurality of dry fibers that are woven into an upper of the footwear.

18. An article comprising a fiber-composite insert for use in conjunction with footwear, the insert comprising a plurality of ribs arranged in a lattice structure, wherein a perimeter of the lattice structure has a form of a human foot, wherein the plurality of ribs includes:
a) a first rib disposed at the perimeter, the first rib comprising a first plurality of continuous fibers disposed in a resin matrix;
b) a second rib that is laterally disposed, extending across a width of the fiber-composite insert, the second rib comprising a second plurality of continuous fibers disposed in the resin matrix; and
c) a third rib longitudinally disposed along a length of the fiber-composite insert, the third rib comprising a third plurality of continuous fibers disposed in the resin matrix.

19. The article of claim 18 wherein the article is footwear, and wherein the fiber-composite insert is disposed in a midsole of the footwear.

20. The article of claim 18 wherein the article is footwear, and wherein a first portion of the fiber-composite insert is disposed is a first footwear component of the footwear, and wherein a second portion of the fiber-composite insert is disposed in a second footwear component of the footwear.
